(19) United States
(12) Patent Application Publication
(10) Pub. No.: US 2024/0268000 A1
(43) Pub. Date: Aug. 8, 2024

(54) HEATING VOLUME ABSORBER

(71) Applicant: VITESCO TECHNOLOGIES GMBH, Regensburg (DE)

(72) Inventors: Valentin GEOFFROY, Toulouse (FR); Kevin GAUDE, Toulouse (FR); Romain JACQUES, Toulouse (FR)

(21) Appl. No.: 18/567,301

(22) PCT Filed: Jun. 21, 2022
(86) PCT No.: PCT/EP2022/066866

§ 371 Date: Dec. 5, 2023

(30) Foreign Application Priority Data
Jun. 28, 2021 (FR) 2106899

(51) Int. Cl. H05B 3/34

(52) U.S. Cl. CPC H05B 3/34

(57) ABSTRACT

A heating volume absorber for a container of liquid of a vehicle, in particular a motor vehicle, includes: a deformable element having a deformable internal part forming an internal chamber, the deformable internal part being constructed and arranged so as to be positioned in the container of liquid, an external body forming an external chamber communicating with the internal chamber, the external body having at least one deformable wall and being constructed and arranged so as to obstruct an orifice of the container of liquid; a heat transfer fluid disposed in the deformable element; and an electric heating device for heating the heat transfer fluid.

### TECHNICAL FIELD OF THE INVENTION

The present invention relates to a heating volume absorber for a container of liquid of a vehicle, in particular a motor vehicle. The technical field of the invention thus relates to vehicle liquid containers.

### TECHNOLOGICAL BACKGROUND OF THE INVENTION

The liquid containers of a vehicle are subjected to the climatic conditions, with temperatures that can drop well below 0° C. when the vehicle is parked for a prolonged period in a very cold area, in particular in certain countries. As a result, the volume of liquid can quickly freeze, even if this volume contains a certain quantity of an additive that lowers its freezing point. In this scenario, the frozen liquid inside the container, which can be formed by a tank or a duct, increases in volume and exerts stresses on the walls thereof that become higher and higher as the outside temperature decreases. This may therefore result in this wall exceeding its strength limits and fracturing, making the tank or duct unusable and requiring replacement thereof.

In order to overcome this drawback, there is for example known from document FR-B1-2967630 a vehicle windshield washer liquid storage tank of which one of the walls comprises a part that is elastically deformable so as to increase the volume of the tank. Thus, when the storage tank is frozen following prolonged negative temperatures, the volume of liquid increases such that it exerts pressure on the walls of the storage tank and mechanically deforms the weakest part, i.e. the elastically deformable part. Then, when the temperature becomes positive again, the ice liquefies and the washing liquid returns to its original volume while the elastically deformable part returns to its initial volume.

Although such an implementation is acceptable for windshield washer liquid, it is however not applicable to other uses for which the liquid cannot be frozen during use of the vehicle. This is the case, for example, for urea dosing modules. Specifically, the urea has to be in its liquid state at most a few seconds after the starting of the vehicle.

### SUMMARY OF THE INVENTION

The heating volume absorber according to one aspect of the invention offers a solution to the problems mentioned above by making it possible, on the one hand, to limit the pressure exerted by freezing of the liquid and, on the other hand, to limit the duration of freezing following starting of the vehicle.

In this context, the invention thus relates, in its broadest sense, to a heating volume absorber for a container of liquid of a vehicle. The heating volume absorber has in particular:
a deformable element having:
   a deformable internal part forming an internal chamber, the deformable internal part being constructed and arranged so as to be positioned in the container of liquid,
   an external body forming an external chamber communicating with the internal chamber, the external body having at least one deformable wall and being constructed and arranged so as to obstruct an orifice of the container of liquid,
a heat transfer fluid disposed in the deformable element, and
an electric heating device for heating the heat transfer fluid.

By virtue of the invention, when the liquid contained in the container of liquid is frozen, its volume increases and exerts pressure on the deformable internal part, which then deforms. During this deformation, the heat transfer fluid contained in the internal chamber of the internal part moves within the external chamber of the external body. The deformable wall of the external body then in turn deforms outward so as to compensate for the deformation of the internal part. Thus, when the liquid in the container of liquid is frozen, its increase in volume is compensated for by the deformation of the absorber according to the invention so as to avoid overpressure in the container of liquid. Furthermore, when it is necessary that this liquid is not frozen, for example during the starting of the vehicle, it is possible to quickly thaw the frozen liquid by activating the electric heating device. Once activated, the heating device increases the temperature of the heat transfer fluid, which in turn heats the liquid in the container of liquid.

In addition to the features that have just been mentioned in the previous paragraph, the heating volume absorber according to one aspect of the invention may have one or more of the additional features from among the following, considered individually or in any technically possible combinations.

According to one nonlimiting aspect of the invention,
the external body has a plug for obstructing the orifice of the container of liquid, the obstruction plug having an orifice for circulation of the heat transfer fluid between the internal chamber and the external chamber, and
the deformable wall is formed by a deformable membrane disposed at a distal end of the external body, the deformable membrane having a first surface in contact with the heat transfer fluid.

According to one nonlimiting aspect of the invention, the deformable membrane is reinforced so as to deform from a determined pressure.

According to one nonlimiting aspect of the invention, the external body has a spring element, the deformable membrane having a second surface disposed opposite the first surface, the second surface coming to bear on the spring element.

According to one nonlimiting aspect of the invention, the obstruction plug has a male part receiving a distal end of the internal part, the male part being passed through by the orifice for circulation of the heat transfer fluid.

According to one nonlimiting aspect of the invention, the distal end of the internal part is force-fitted on the male part of the obstruction plug.

According to one nonlimiting aspect of the invention, the distal end of the internal part is overmolded on the male part of the obstruction plug.

According to one nonlimiting aspect of the invention, the electric heating device is disposed in contact with the heat transfer fluid contained in the external chamber.

According to one nonlimiting aspect of the invention, a part of the electric heating device is overmolded in the external body.

According to one nonlimiting aspect of the invention, the distal end of the internal part has an external peripheral seal constructed and arranged so as to come into contact with an internal wall of the container of liquid.

The invention and its various applications will be better understood upon reading the following description and studying the accompanying figures.

### BRIEF DESCRIPTION OF THE FIGURES

The figures are presented by way of entirely nonlimiting indication of the invention.

FIG. 1 illustrates one exemplary embodiment of a heating volume absorber for a container of liquid of a vehicle according to one nonlimiting aspect of the invention.

FIG. 2 shows another exemplary embodiment of a heating volume absorber for a container of liquid of a vehicle according to another nonlimiting aspect of the invention.

FIG. 3 illustrates a different exemplary embodiment of a heating volume absorber for a container of liquid of a vehicle according to one nonlimiting aspect of the invention.

### DETAILED DESCRIPTION

Unless otherwise specified, one and the same element appearing in different figures has a single reference.

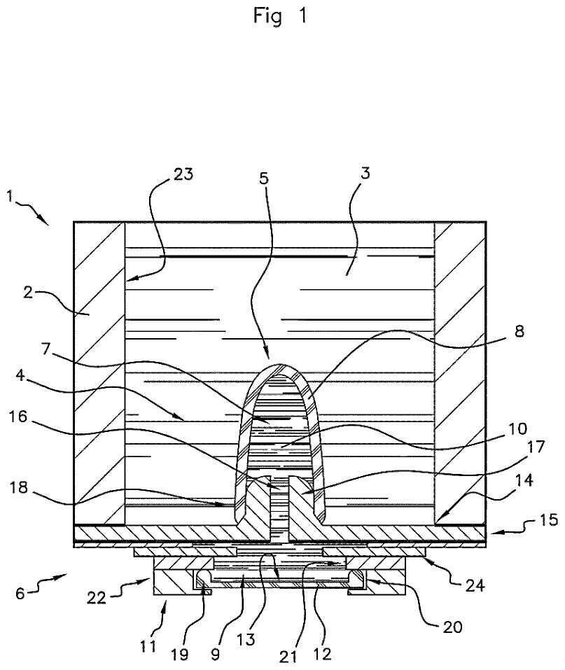

FIG. 1 illustrates a nonlimiting exemplary embodiment of a heating volume absorber 1 for a container 2 of liquid 3 of a vehicle, in particular a motor vehicle.

In a nonlimiting manner, the container 2 of liquid can for example be formed by a tank or a duct and the liquid 3 can, for its part, be formed by urea.

The heating volume absorber 1 has a deformable element 4 provided with an internal part 5 and an external body 6.

The internal part 5 is deformable and forms an internal chamber 7. The deformable internal part 5 is positioned in the container 2 of liquid.

This internal part 5 has in particular a deformable surface 8. This deformable surface 8 can for example be made of elastomer and have a thickness of 1 mm.

The external body 6 forms an external chamber 9.

The internal chamber 7 and the external chamber 9 communicate together and contain a heat transfer fluid 10.

The heat transfer fluid 10 is selected so as to have a freezing point lower than the freezing point of the liquid 3 in the container 2 of liquid.

The external body 6 has, at a distal end 11, a deformable wall 12 constituted in this exemplary embodiment of a deformable membrane. This deformable membrane 12 has a first surface 13 in contact with the heat transfer fluid 10.

Distal is understood to mean the end furthest from the interior of the container 2 of liquid.

The external body 6 obstructs an orifice 14 of the container 2 of liquid.

In this nonlimiting exemplary embodiment, the external body 6 has a plug 15 for obstructing the orifice 14 of the container 2 of liquid. So as to ensure a perfect seal between the container 2 of liquid and the exterior, the obstruction plug 15 can for example be welded onto the container 2 of liquid by a laser welding process.

The obstruction plug 15 has an orifice 16 for circulation of the heat transfer fluid between the internal chamber 7 and the external chamber 9.

The obstruction plug 15 also has a male part 17 receiving a distal end 18 of the internal part 5. It should be noted that the male part 17 is passed through by the orifice 16 for circulation of the heat transfer fluid 10.

In one nonlimiting exemplary embodiment, the distal end 18 of the internal part 5 is force-fitted on the male part 17 of the obstruction plug 15.

In a different nonlimiting implementation, the distal end 18 of the internal part 5 is overmolded on the male part 17 of the obstruction plug 15.

The peripheral surface 19 of the deformable membrane 12 is positioned in a first groove 20 formed in the internal surface 21 of the external body 6. More particularly, this first groove 20 is formed by the junction of the obstruction plug 15 and a coaxial cap 22 of the external body 6. The obstruction plug 15 and the cap 22 are welded to each other for example by means of a laser welding process.

Thus, in operation, when the liquid 3 is frozen, its volume increases and exerts pressure on the deformable surface 8 of the deformable internal part 5. The deformable internal part 5 deforms and the heat transfer fluid 10 contained in the internal chamber 7 circulates through the circulation orifice 16 so as to reach the external chamber 9 of the external body 6.

The deformable membrane 12 of the external body 6 then in turn deforms so as to increase the volume of the external chamber 9. Thus, the absorber 1 makes it possible to limit the pressure exerted on the internal walls 23 of the container 2 of liquid during prolonged freezing phases.

The heating volume absorber 1 also has an electric heating device 24 for heating the heat transfer fluid 10.

In this exemplary embodiment, the electric heating device 24 is disposed in contact with the heat transfer fluid 10 that is contained in the external chamber 9.

In one nonlimiting implementation, this electric heating device 24 can for example be formed by a washer forming a resistor. This washer can be overmolded in the obstruction plug 15.

According to another nonlimiting embodiment, the electric heating device 24 can be formed by two resistive metal bars overmolded in the obstruction plug 15.

Thus, during the starting of the vehicle, if the outside temperature is negative, an engine management computer can activate the electric heating device 24. The liquid 3 in the container 2 that is frozen is then heated locally by the heat transfer liquid 10 of the heating volume absorber 1.

In one nonlimiting implementation, the heating volume absorber 1 is disposed at the last freezing point of a duct so as to be able to prevent, by activating the electric heater 24, the freezing of this last freezing point.

In one nonlimiting implementation, the deformable membrane 12 is reinforced so as to deform only from a determined pressure. Such a reinforced deformable membrane 12 makes it possible to set the force necessary for the deformation of the heating volume absorber 1.

Specifically, in normal operation, the hydraulic pressure in the container 2 of liquid is likely to change, for example between 7 bars and 10 bars. In order to prevent the heating volume absorber 1 from deforming in this value range, the deformable membrane 12 can be reinforced by means of a fiber. The deformation of this reinforced deformable membrane 12 can for example be authorized only starting from 15 bars. Thus, the internal part 5 and the external body 6 of the heating volume absorber 1 deform only when the pressure exerted by the liquid 3 is greater than 15 bars.

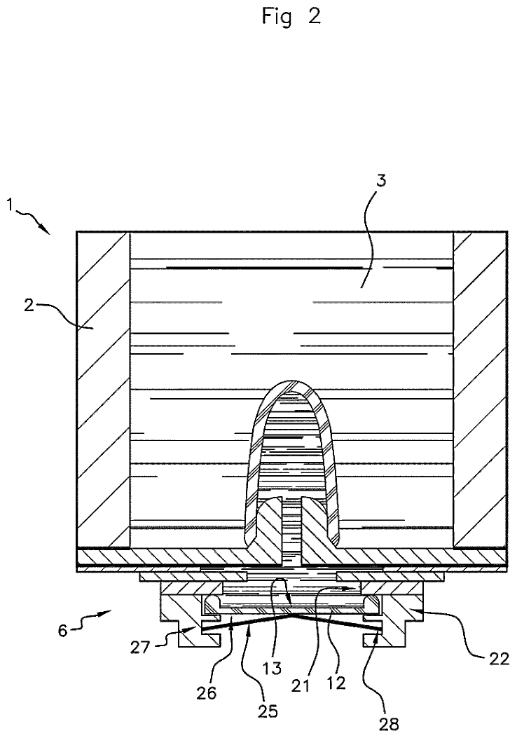

FIG. 2 illustrates another nonlimiting exemplary embodiment of a heating volume absorber 1 for a container 2 of liquid 3 of a vehicle.

In this exemplary embodiment, the external body 6 has a spring element 25.

The deformable membrane 12 has a second surface 26 disposed opposite the first surface 13. The second surface 26 bears on the spring element 25.

The spring element 25 can, in a nonlimiting manner, be formed by a leaf spring or an elastic washer, also known as a Belleville washer.

As illustrated in FIG. 2, in the case of an elastic washer 25, the peripheral surface 27 of the elastic washer 25 is positioned in a second groove 28 formed in the internal surface 21 of the external body 6. More particularly, this second groove 28 is formed in the cap 22.

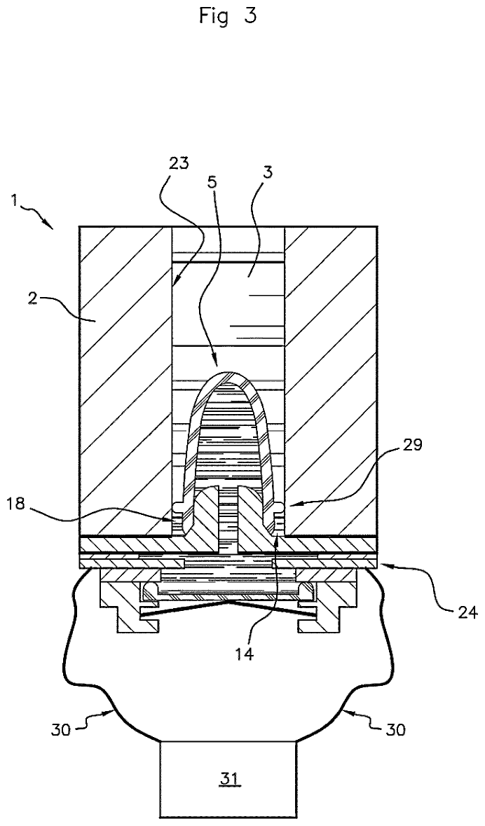

FIG. 3 illustrates another nonlimiting exemplary embodiment of a heating volume absorber 1 for a container 2 of liquid 3 of a vehicle.

In this implementation, the distal end 18 of the internal part 5 has an external peripheral seal 29 constructed and arranged so as to come into contact with the internal wall 23 of the container 2 of liquid 3. This particular embodiment can be implemented when a secure seal between the orifice 14 of the container 2 of liquid and the exterior is sought.

In this FIG. 3, electrical wires 30 are illustrated. They are connected to a control device 31 that makes it possible to supply electric power to the electric heating device 24 when the outside temperature is negative.

The various abovementioned aspects of the invention have numerous advantages. Among these, mention can be made of:
the limitation of pressure exerted on the internal walls of a container of liquid of a motor vehicle by the deformation of the internal part and the external body,
the local thawing of the liquid disposed in a critical area of the container of liquid.

1. A heating volume absorber for a container of liquid of a vehicle, in particular a motor vehicle, said absorber being characterized in that it has comprising:
a deformable element having:
a deformable internal part forming an internal chamber, said deformable internal part being constructed and arranged so as to be positioned in said container of liquid,
an external body forming an external chamber communicating with said internal chamber, said external body having at least one deformable wall and being constructed and arranged so as to obstruct an orifice of said container of liquid,
a heat transfer fluid disposed in said deformable element, and
an electric heating device for heating said heat transfer fluid.

2. The absorber as claimed in claim 1, wherein:
the external body has a plug for obstructing the orifice of the container of liquid, said obstruction plug having an orifice for circulation of the heat transfer fluid between the internal chamber and the external chamber, and wherein
the deformable wall is formed by a deformable membrane disposed at a distal end of said external body, said deformable membrane having a first surface in contact with said heat transfer fluid.

3. The absorber as claimed in claim 2, wherein the deformable membrane is reinforced so as to deform from a determined pressure.

4. The absorber as claimed in claim 2, wherein the external body has a spring element, the deformable membrane having a second surface disposed opposite the first surface, said second surface coming to bear on said spring element.

5. The absorber as claimed in claim 2, wherein the obstruction plug has a male part receiving a distal end of the internal part, said male part being passed through by the orifice for circulation of the heat transfer fluid.

6. The absorber as claimed in claim 5, wherein the distal end of the internal part is force-fitted on the male part of the obstruction plug.

7. The absorber as claimed in claim 5, wherein the distal end of the internal part is overmolded on the male part of the obstruction plug.

8. The absorber as claimed in claim 1, wherein the electric heating device is disposed in contact with the heat transfer fluid contained in the external chamber.

9. The absorber as claimed in claim 8, wherein a part of the electric heating device is overmolded in the external body.

10. The absorber as claimed in claim 1, wherein the distal end of the internal part has an external peripheral seal constructed and arranged so as to come into contact with an internal wall of the container of liquid.

11. The absorber as claimed in claim 3, wherein the obstruction plug has a male part receiving a distal end of the internal part, said male part being passed through by the orifice for circulation of the heat transfer fluid.

12. The absorber as claimed in claim 11, wherein the distal end of the internal part is force-fitted on the male part of the obstruction plug.

13. The absorber as claimed in claim 11, wherein the distal end of the internal part is overmolded on the male part of the obstruction plug.

14. The absorber as claimed in claim 13, wherein the electric heating device is disposed in contact with the heat transfer fluid contained in the external chamber.

15. The absorber as claimed in claim 14, wherein a part of the electric heating device is overmolded in the external body.

16. The absorber as claimed in claim 15, wherein the distal end of the internal part has an external peripheral seal constructed and arranged so as to come into contact with an internal wall of the container of liquid.

17. The absorber as claimed in claim 4, wherein the obstruction plug has a male part receiving a distal end of the internal part, said male part being passed through by the orifice for circulation of the heat transfer fluid.

18. The absorber as claimed in claim 2, wherein the electric heating device is disposed in contact with the heat transfer fluid contained in the external chamber.

19. The absorber as claimed in claim 3, wherein the electric heating device is disposed in contact with the heat transfer fluid contained in the external chamber.

20. The absorber as claimed in claim 4, wherein the electric heating device is disposed in contact with the heat transfer fluid contained in the external chamber.
